(19) United States
(12) Patent Application Publication
(10) Pub. No.: US 2026/0045724 A1
(43) Pub. Date: Feb. 12, 2026

(54) APPARATUS AND METHOD FOR ALIGNING POGO PIN

(71) Applicant: ENSCAPE CO., LTD., Yongin-si (KR)

(72) Inventors: Dong Hyun Jung, Hwaseong-si (KR); Ji Man Ryu, Suwon-si (KR); Seong Gi Kim, Asan-si (KR); In Ho Ka, Seongnam-si (KR); Hyeok Gi Gwon, Yongin-si (KR); Sang Jin Choi, Seongnam-si (KR); Sang Baek Kim, Seongnam-si (KR)

(21) Appl. No.: 19/268,620

(22) Filed: Jul. 14, 2025

(30) Foreign Application Priority Data
Aug. 9, 2024 (KR) 10-2024-0106520
Aug. 14, 2024 (KR) 10-2024-0109277

(51) Int. Cl. H01R 13/24; H01F 7/02

(52) U.S. Cl. CPC H01R 13/2407; H01F 7/0257

(57) ABSTRACT

Disclosed is an apparatus for aligning a pogo pin, including: a seating unit configured to support and seat a lower end portion of the pogo pin on an upper surface thereof; a lower magnet configured to provide a magnetic force from below the seating unit so that the pogo pin can maintain a standing state on the seating unit; and a posture adjuster provided above the pogo pin and configured to adjust the posture of the pogo pin based on the magnetic force. The apparatus for aligning the pogo pin according to the disclosure has an effect on quickly and accurately aligning the pogo pin in a non-contact manner.

### CROSS REFERENCE TO RELATED APPLICATIONS

Priority to Korean Patent Application No. 10-2024-0106520 filed on Aug. 9, 2024, and Korean Patent Application No. 10-2024-0109277 filed on Aug. 14, 2024, the entire disclosure of which is incorporated by reference herein, is claimed.

### BACKGROUND OF THE INVENTION

### Field of the Invention

The disclosure relates to an apparatus and method for aligning a pogo pin. More specifically, the disclosure relates to an alignment apparatus and method utilizable in manufacturing a pogo pin or inspecting the outer appearance of the pogo pin. Further, the disclosure relates to an alignment apparatus and method capable of aligning the posture of a pogo pin contactlessly using a magnet.

This application is the result of the scale-up technology commercialization program (Development of Equipment for Outer Appearance Inspection of Pogo Pins Based on Reconstruction Production System and Mass Production Verification by Demand Companies, Project No.: P0021129), which was funded by Ministry of Trade, industry and Energy and conducted under the management of Korea Institute for the Advancement of Technology.

### Description of the Related Art

With development of artificial intelligence (AI), Internet of things (IoT), big data, etc. the transition to a data economy is rapidly increasing a demand for semiconductors in various industrial fields such as autonomous vehicles, robots, 5G wireless communication, and mobile home appliances. In a semiconductor process, pogo pins are required as a key component for testing the performance and reliability of a semiconductor. In connection with the pogo pins, Korean Patent No. 1204273 has been disclosed.

The pogo pins are produced in various specifications to have a minimum diameter of about 0.15 mm and a minimum length of 1 mm. Till now, the appearance of the pogo pin has been inspected with the naked eyes using a microscope, and classification work has also been carried out manually, thereby resulting in a problem of lowering a production efficiency.

To solve the conventional problem, an apparatus for automatically inspecting the appearance of the pogo pin is needed, and an apparatus for aligning the position of the pogo pin is also essentially needed.

The foregoing problem arises in not only the pogo pins but also small electronic components.

### DOCUMENTS OF RELATED ART

(Patent Document 1) Korean Patent No. 1204273 (published on Nov. 23, 2012)

### SUMMARY OF THE INVENTION

An aspect of the disclosure is to provide an apparatus and method for aligning a pogo pin to overcome conventional difficulty in aligning the pogo pin.

According to an embodiment of the disclosure, there is provided an apparatus for aligning a pogo pin includes: a seating unit configured to support and seat a lower end portion of the pogo pin on an upper surface thereof; a lower magnet configured to provide a magnetic force from below the seating unit so that the pogo pin can maintain a standing state on the seating unit; and a posture adjuster provided above the pogo pin and configured to adjust.

Meanwhile, an upper magnet may be provided blow the posture adjuster.

Further, a lower end of the posture adjuster may be spaced apart at a predetermined distance from the upper surface of the seating unit, and the predetermined distance may be determined to be greater than the length of the pogo pin.

Further, the posture adjuster may be configured to move the upper magnet in a horizontal direction.

Meanwhile, the posture adjuster may include: an upper magnet holder configured to hold the upper magnet; and at least one adjustment module configured to move the upper magnet holder.

Further, the adjustment module may be provided in plural and be configured to move along an orthogonal coordinate system.

Meanwhile, the adjustment module may be provided in plural and be configured to move along a polar coordinate system.

Further, the posture adjuster may be configured to uprightly erect the pogo pin according to positions of the upper magnet.

Meanwhile, the apparatus may further include a coaxial aligner configured to move the seating unit on a horizontal plane.

Meanwhile, the posture adjuster may be controlled to operate after the coaxial aligner aligns the position of the seating unit.

Meanwhile, the posture adjuster may be configured to move horizontally depending on the coaxial aligner.

Further, the posture adjuster may be configured to move horizontally independently of the coaxial aligner.

According to an embodiment of the disclosure, there is provided a method of aligning a pogo pin, including: acquiring an image of the pogo pin; analyzing the image to extract information about a posture and position of the pogo pin from the image; and adjusting the posture to change a direction of a magnetic force acting on the pogo pin so as to adjust the posture of the pogo pin based on the information.

Meanwhile, a seating unit on which the pogo pin is seated may be configured to rotate, and the method may further include coaxially aligning a central axis of the pogo pin with a rotation center of the seating unit based on the information.

Meanwhile, the acquiring the image of the pogo pin may be performed using a lighting unit and a camera provided on both sides with the pogo pin therebetween.

Further, the acquiring the image of the pogo pin may be performed using a silhouette image of the pogo pin.

Meanwhile, the method may further include adjusting an angle to rotate the seating unit at a predetermined angle so as to adjust a direction in which the pogo pin appears in the camera.

Further, the acquiring the image may be performed for each direction of the pogo pin.

Meanwhile, the analyzing the image, the adjusting the posture, and the coaxially aligning the pogo pin may be performed after acquiring the images of the pogo pin from a predetermined number of directions.

In addition, the analyzing the image, the adjusting the posture, and the coaxially aligning the pogo pin may be performed after acquiring the images of the pogo pin from the respective directions.

Further, the adjusting the posture of the pogo pin may be performed by moving a position of the magnet on a horizontal plane along an orthogonal coordinate system.

Meanwhile, the coaxially aligning the pogo pin may be performed by moving the seating unit along an orthogonal coordinate system.

### BRIEF DESCRIPTION OF THE DRAWINGS

FIG. 1 is a view showing a pogo pin to be subjected to inspection according to the disclosure.

FIG. 2 is a perspective view of an apparatus for aligning a pogo pin according to a first embodiment of the disclosure.

FIG. 3 is an exploded perspective view of a lower module in the first embodiment.

FIG. 4 is an exploded perspective view of an upper module in the first embodiment.

FIG. 5 is a perspective view showing a horizontal movement component of a coaxial aligner in the first embodiment.

FIG. 6 is an operating state view according to the first embodiment.

FIGS. 7A and 7B are conceptual views showing the effects of an upper magnet according to the first embodiment on the posture of a pogo pin seated on a seating unit.

FIGS. 8A and 8B are views showing the postures of a pogo pin according to the positions of the upper magnet in the first embodiment.

FIGS. 9A, 9B and 9C are using state views showing the concept of adjusting the posture of a pogo pin and coaxially aligning the pogo pin in the first embodiment.

FIG. 10 is an operating state view showing a rotating operation based on a rotation unit in the state that the posture of a pogo pin is adjusted and coaxially aligned according to the first embodiment.

FIG. 11 is a view showing an alternative example of a posture adjuster according to the first embodiment of the disclosure.

FIG. 12 is a flowchart showing a method of aligning a pogo pin according to the first embodiment of the disclosure.

FIG. 13 is a flowchart showing a method of aligning a pogo pin according to a second embodiment of the disclosure.

FIG. 14 is a flowchart showing a method of aligning a pogo pin according to an alternative example of the second embodiment of the disclosure.

FIG. 15 is a flowchart showing a method of aligning a pogo pin according to a third embodiment of the disclosure.

FIG. 16 is a flowchart showing a method of aligning a pogo pin according to a fourth embodiment of the disclosure.

FIGS. 17A, 17B, 17C and 17D are a view showing image acquired in a process of aligning the posture of a pogo pin according to the disclosure.

FIG. 18 shows an image acquired by capturing a pogo pin coaxially aligned and uprightly erect according to the disclosure.

FIG. 19 is a perspective view of an apparatus for inspecting the appearance of a pogo pin according to an embodiment of the disclosure.

FIG. 20 is an exploded perspective view of an apparatus for inspecting the appearance of a pogo pin according to an embodiment of the disclosure.

FIG. 21 is a perspective view showing a posture adjuster included in an apparatus for inspecting the appearance of a pogo pin according to an embodiment of the disclosure.

FIGS. 22A and 22B are conceptual views showing a magnet used in a posture adjusting operation according to the disclosure and the lines of magnetic force.

FIGS. 23A and 23B are conceptual views showing the postures of a pogo pin based on a posture adjusting operation for the pogo pin according to the disclosure.

FIGS. 24A and 24B are cross-sectional views showing states of using a posture adjuster in a posture adjusting operation for a pogo pin according to the disclosure.

FIGS. 25A and 25B are cross-sectional views showing states of using a coaxial aligner in a coaxial aligning operation for a pogo pin according to the disclosure.

FIG. 26 shows a rotating operation of a pogo pin in an inspection image acquiring operation according to the disclosure.

### DETAILED DESCRIPTION OF THE INVENTION

Below, an apparatus and method for aligning a pogo pin according to an embodiment of the disclosure will be described in detail with reference to the accompanying drawings. In the following description, the names of components used may be referred to as other names in this art. However, these components may be considered as equivalent components in alternative embodiments if they are functionally similar or identical to each other. Further, the reference numerals of the components are merely given for the convenience of description. However, the components indicated by the reference numerals in the accompanying drawings are not limited by those shown therein. Likewise, if components are functionally similar or identical to each other even though they are partially modified in the drawings according to alternative embodiments, the components may be considered as the equivalent components. Further, if components are recognized as components that should be included at the level of those skilled in the art, descriptions thereof will be omitted.

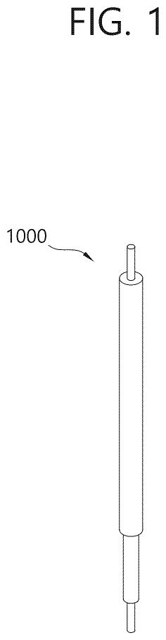

FIG. 1 is a view showing a pogo pin to be subjected to inspection according to the disclosure.

According to the disclosure, an electronic component to be aligned in position is formed to extend a predetermined length and have magnetism. For example, as shown in FIG. 1, the electronic component according to the disclosure may be a pogo pin. The pogo pin 1000 is generally shaped like a cylinder, of which a curved lateral surface, a top surface, and a bottom surface need to undergo an appearance inspection. In particular, the pogo pin 1000 is required to rotate 360 degrees for the appearance inspection because its lateral surface is curved.

Meanwhile, a vision camera module is generally used to perform the appearance inspection. When two conditions are satisfied while rotating the pogo pin 1000 to perform the appearance inspection for the lateral surface of the pogo pin 1000, the accuracy of the appearance inspection may be improved. The first condition is that the pogo pin 1000 is uprightly erect in a vertical direction, and the second condition is that the center of the pogo pin 1000 and the rotation center for rotating the pogo pin 1000 are coaxially aligned. To meet these conditions, a mechanical alignment means (e.g., a gripper) may be used to correct the posture of the pogo pin 1000 and align the pogo pin 1000 with a rotation axis, but the outer surface of the pogo pin 1000 may be obscured by the alignment means while the alignment means holds the pogo pin 1000. In particular, the smaller the size of an inspection target, such as the pogo pin 1000, the greater the proportion of the outer surface that may be obscured by the alignment means. In this case, if the tip of the alignment means is made smaller to minimize the area of the pogo pin 100 obscured by the alignment means, the pogo pin 1000 may be damaged due to stress concentrated on the surface of the pogo pin 1000 during the process of holding the pogo pin 1000.

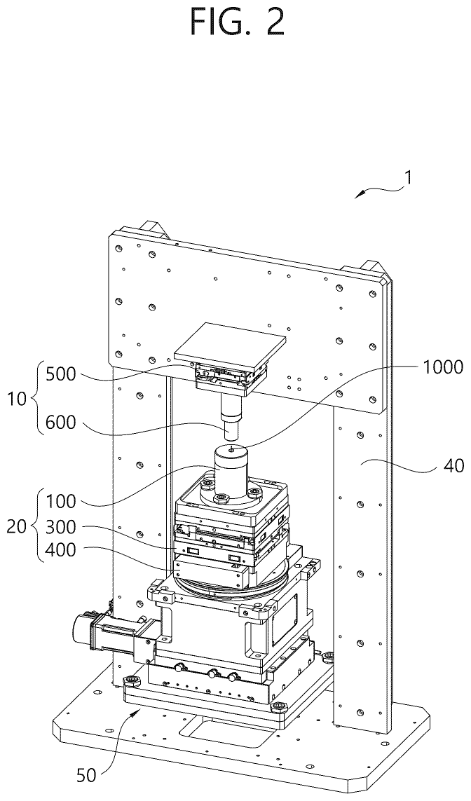

Below, an apparatus for aligning a pogo pin according to a first embodiment of the disclosure will be described with reference to FIGS. 2 to 9.

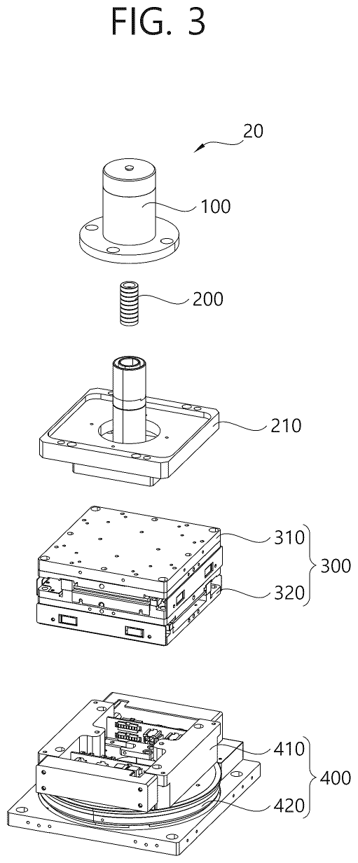

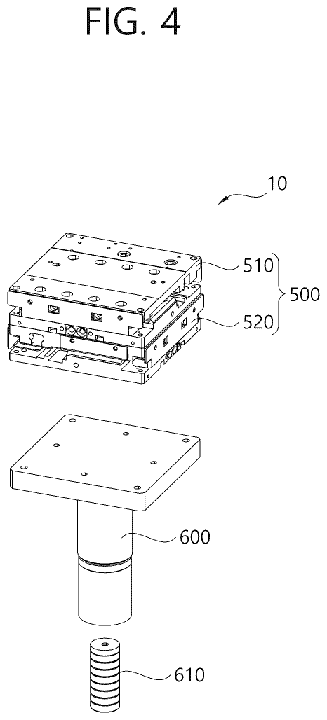

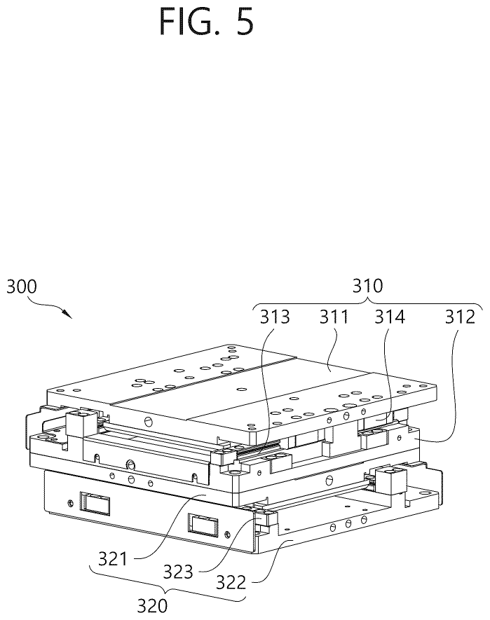

FIG. 2 is a perspective view of an apparatus for aligning a pogo pin according to a first embodiment of the disclosure, FIG. 3 is an exploded perspective view of a lower module in the first embodiment, FIG. 4 is an exploded perspective view of an upper module in the first embodiment, and FIG. 5 is a perspective view showing a horizontal movement component of a coaxial aligner in the first embodiment.

Referring to FIGS. 2 to 5, the apparatus 1 for aligning a pogo pin according to the first embodiment of the disclosure may include an upper module 10 and a lower module 20. A space between the upper module 10 and the lower module 20 may allow the pogo pin 1000 to be transported from the outside or taken out to the outside.

The lower module 20 may be configured to seat the transported pogo pin 1000 thereon and to align the rotation axis of a rotation unit 400 (to be described later) coaxially with the longitudinal central axis of the pogo pin 1000.

The upper module 10 may be configured to operate independently of the lower module 20. A posture adjuster 500 may be configured to be relatively positioned in a horizontal direction on a vertical frame 40. In this case, a basic position of the posture adjuster 500 may be aligned coaxially with the central axis of the rotation unit 400 of the lower module 20.

The lower module 20 may include a seating unit 100, a lower magnet 200, a coaxial aligner 300, a rotation unit 400 and a coaxial adjuster 50.

The seating unit 100 is configured so that the pogo pin 1000 can be seated on the top thereof. At least a portion of the upper surface of the seating unit 100 forms a predetermined area, and may be configured to support a longitudinal end portion of the pogo pin 1000. The seating unit 100 is subjected to a magnetic force by the lower magnet 200 (to be described below), so that the pogo pin 1000 can be seated on the seating unit 100 in a generally uprightly erect posture.

The upper surface of the seating unit 100 may be configured to prevent an end surface of the pogo pin 1000 from slipping during contact. For example, the upper surface of the seating unit 100 may undergo surface treatment to increase friction

The lower magnet 200 may be provided below the seating unit 100. The lower magnet 200 applies a magnetic force to the upper surface of the seating unit 100 to maintain the pogo pin 1000, which is seated on the upper surface (seating surface) of the seating unit 100, in the uprightly erect posture. An angle formed between each pogo pin 1000 and the seating unit 100 when seated on the seating surface may not be the same each time

The lower magnet 200 may be provided under the seating unit 100 and configured to exert the magnetic force on the pogo pin 1000 seated on the seating surface. The pogo pin 1000 secured on the seating unit 100 may maintain the posture in the secured state by the magnetic force of the lower magnet 200. The lower magnet 200 may be provided inside the seating unit 100 and may be supported by a lower magnet holder 210 so as not to come into direct contact with the pogo pin 1000. In addition, the lower magnet 200 may be configured as a plurality of magnets to exert the magnetic force together on the pogo pin 1000.

The coaxial aligner 300 is provided to coaxially align the center of the pogo pin 1000 with the rotation center when the pogo pin 1000 is in the uprightly erect posture. The coaxial aligner 300 may include driving elements based on an orthogonal coordinate system. As an example, the coaxial aligner 300 may include a first alignment module 310 and a second alignment module 320.

The first alignment module 310 and the second alignment module 320 may be configured to move linearly on a horizontal plane. The second alignment module 320 may be coupled to a lower portion of the first alignment module 310. The position of the first alignment module 310 may be adjusted in a first direction, for example in an x direction, on the horizontal plane. The position of the second alignment module 320 may be adjusted in a direction orthogonal to the first direction, for example, in a y direction, on the horizontal plane.

The first alignment module 310 may include a first upper portion 311 and a first lower portion 312. Each of the first upper portion 311 and the second lower portion 312 may be shaped like a flat plate. The first upper portion 311 and the first lower portion 312 may be coupled by a first guide 313 to constrain the moving directions thereof. A first actuator 314 may be provided between the first upper portion 311 and the second upper portion 311 to adjust a relative position between the first upper portion 311 and the first lower portion 312.

The second alignment module 320 may include components similar to those of the first alignment module 310. For example, the second alignment module 320 may include a second upper portion 321, a second lower portion 322, a second guide 323 and a second actuator (not shown).

The second lower portion 322 of the second alignment module 320 is coupled to a rotary table 410 and configured to rotate together with the rotation of the rotary table.

Meanwhile, according to the disclosure, the first actuator 314 and the second actuator (not shown) may be configured as linear motors, but are not limited thereto, and may include driving elements capable of linear movement, such as a ball-screw mechanism.

Based on the operations of the coaxial aligner 300, the horizontal position of the central axis of the pogo pin 1000 may be adjusted within a predetermined range, and ultimately, the central axis of the pogo pin 1000 may be aligned coaxially with the rotation center of the rotation unit 400.

The rotation unit 400 may be configured to adjust the angles of the coaxial aligner 300, the posture adjuster 500 and the seating unit 100. When the coaxial aligner 300 is rotated around a height direction axis by the rotation unit 400, the seating unit 100 and the lower magnet 200 may be rotated together at the same angle.

The rotation unit 400 may include the rotary table 410 and a rotation actuator 420.

The rotary table 410 may be configured to rotate infinitely by the rotation actuator 420. However, this is merely an example, and a wire-type connector may be provided to constrain the rotation of the rotary table 410 within a certain rotation angle. However, even in this case, a rotation of at least 360 degrees should be guaranteed.

The coaxial adjuster 50 is configured to precisely move the lower module 20 provided on the upper side in a certain direction. The coaxial adjuster 50 is provided to adjust the position of the lower module 20 in a case where the diameter of the pogo pin 1000 is different.

The upper module 10 may include the posture adjuster 500, an upper magnet 610, and an upper magnet holder 600.

The posture adjuster 500 is configured to adjust the posture of the pogo pin 1000 seated on the seating unit 100. The posture adjuster 500 is configured to adjust the direction of the magnetic force exerted on the pogo pin 1000 by the upper magnet 610 provided above the pogo pin 1000. The direction of the magnetic force may be adjusted by adjusting the relative position between the pogo pin 1000 and the upper magnet 610.

The posture adjuster 500 may be configured to move horizontally relative to the seating unit 100 from above the seating unit 100. The posture adjuster 500 may include a first adjustment module 510 and a second adjustment module 520.

The upper magnet 610 is provided above the seating unit 100 and configured to exert a magnetic force on the pogo pin 1000 seated on the upper end of the seating unit 100. One or more upper magnets 610 may be provided. The upper magnet holder 600 may hold at least one upper magnet 610 arranged in a vertical direction. The lower end of the upper magnet holder 600 may be spaced apart from the upper surface of the seating unit 100. The space may be greater than the length of the pogo pin 1000 so that the pogo pin 1000 can be transported from the outside or taken out to the outside.

The position of the upper magnet holder 600 may be adjusted depending on change in the position of the first adjustment module 510.

The first adjustment module 510 may be configured to move the position of the upper magnet 610 along the first direction in the horizontal direction. Additionally, the second adjustment module 520 may be configured in a second direction orthogonal to the moving direction of the first adjustment module 510 in the horizontal direction.

The first adjustment module 510 and the second adjustment module 520 may include components based on the orthogonal coordinate system like those of the first alignment module 310 and the second alignment module 320 described with reference to FIG. 5.

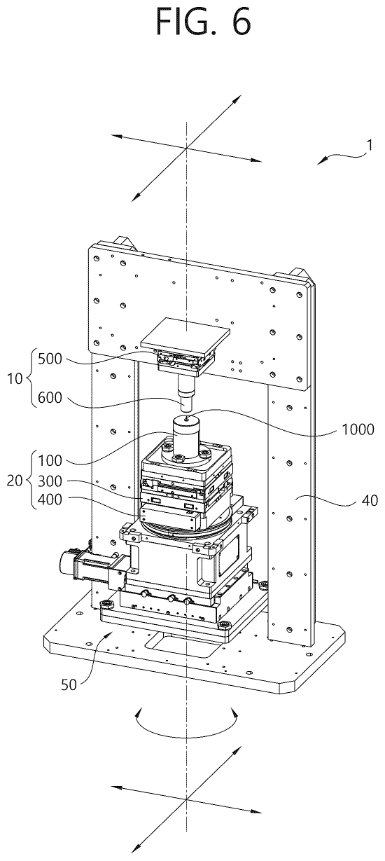

FIG. 6 is an operating state view according to the first embodiment.

Referring to FIG. 6, according to the first embodiment of the disclosure, the position of the seating unit 100 may be moved horizontally by the operation of the coaxial aligner 300. In addition, the horizontal position of the upper module 10 may be adjusted depending on the horizontal movement of the coaxial aligner 300, and additionally, the posture adjuster 500 may be moved horizontally to uprightly erect the pogo pin 1000.

By the operations of the posture adjuster 500 and the coaxial aligner 300, the posture of the pogo pin 1000 may be adjusted or the horizontal position of the pogo pin 1000 may be moved.

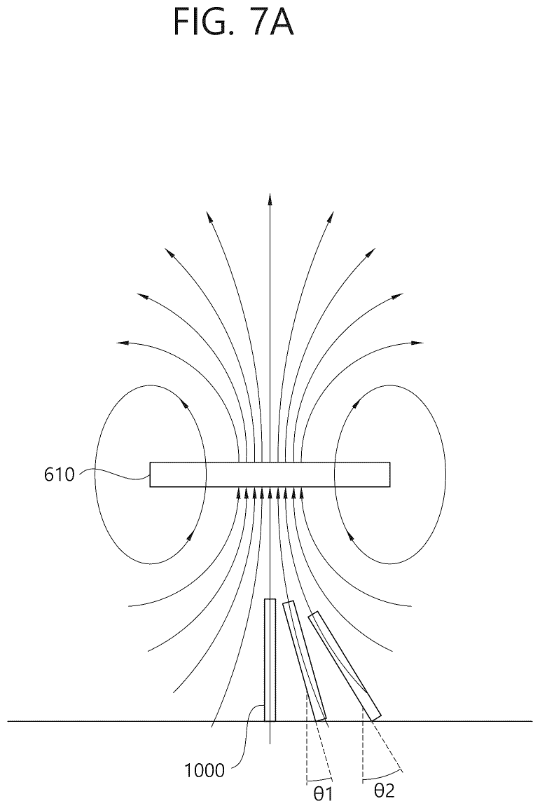

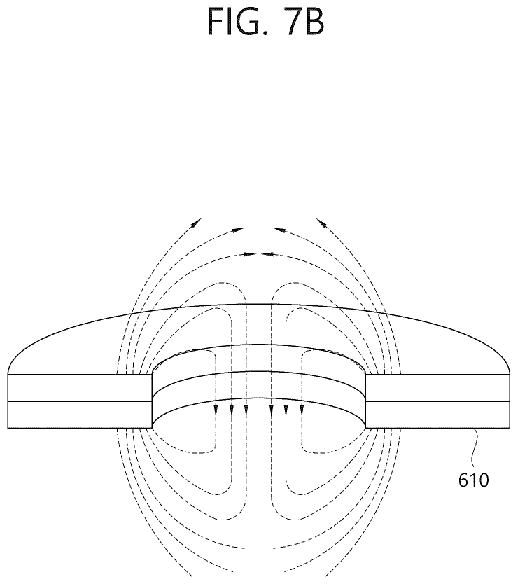

FIGS. 7A and 7B are conceptual views showing the effects of an upper magnet according to the first embodiment on the posture of a pogo pin seated on a seating unit.

Referring to FIG. 7A, according to the first embodiment of the disclosure, the upper magnet 610 may be formed as a disk, and the pogo pin 1000 may receive the magnetic force in various directions depending on the relative positions from the center of the upper magnet 610. At the center of the upper magnet 610, magnetic field lines may appear in a generally vertical direction. The inclinations θ1 and θ2 of the magnetic field lines may increase as a distance from the center of the upper magnet 610 increases. Therefore, the posture (angle or inclination) of the pogo pin 1000 is contactlessly adjustable by changing the direction of the magnetic field line acting on the pogo pin 1000 to adjust the relative position between the center of the upper magnet 610 and the pogo pin 1000.

Referring to FIG. 7B, according to an embodiment of the disclosure, the upper magnet 610 may be shaped like a ring. When the upper magnet 610 has a ring shape, the magnetic field lines appear in a vertical direction at the center of a hollow space formed in a central portion, and a magnetic flux increases, thereby more easily adjusting the posture of the pogo pin 1000. However, the shape of the upper magnet 610 is merely described as an example, and the upper magnet 610 is not limited to this example.

That is, there are various embodiments according to the disclosure as long as the upper magnet 610 generates vertical magnetic field lines at the center portion thereof and the directions of the magnetic field lines are changed as moving away from the center. Accordingly, the upper magnet 610 may have various shapes to adjust the posture of the pogo pin 1000 that is magnetically settled on the lower side. As an example, the upper magnet 610 may have a polygonal cross-section, and may have a hole at the center thereof in the vertical direction so that the magnetic force can be concentrated at the center. In addition, the upper magnet 610 may be shaped like a thin plate or a thick column.

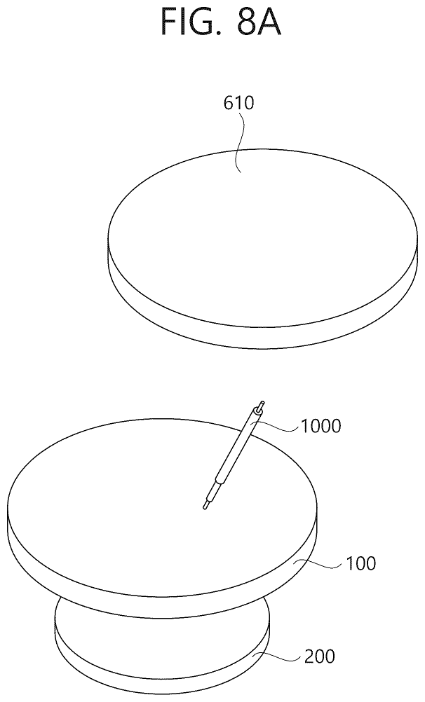

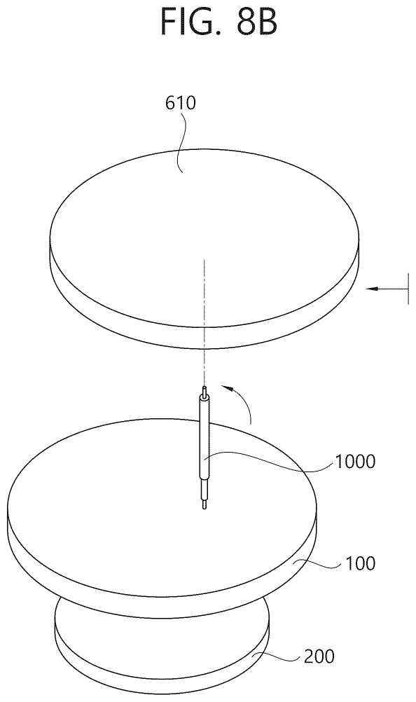

FIGS. 8A and 8B are views showing the postures of a pogo pin according to the positions of the upper magnet in the first embodiment.

Referring to FIG. 8A, according to the disclosure, when the pogo pin 1000 is seated on the upper surface (seating surface) of the seating unit 100, the position and posture of the pogo pin 1000 may be fixed by the lower magnet 200. The posture of the pogo pin 1000 may be based on the magnetic force of the lower magnet 200 and the influence of the gravity while its lower end is supported on the seating unit 100. In addition, the position of the pogo pin 1000 may be based on a complex force with the magnetic force of the upper magnet 610.

Referring to FIG. 8B, the posture of the pogo pin 1000 may be changed to the uprightly erect posture as the central axis of the upper magnet 610 on the seating surface of the seating unit 100 gets closer to a point where the lower end of the pogo pin 1000 is in contact with the seating unit 100. That is, the posture of the pogo pin 1000 may be aligned in a non-contact manner by adjusting the horizontal position of the upper magnet 610 relative to the point where the lower end of the pogo pin 1000 is supported.

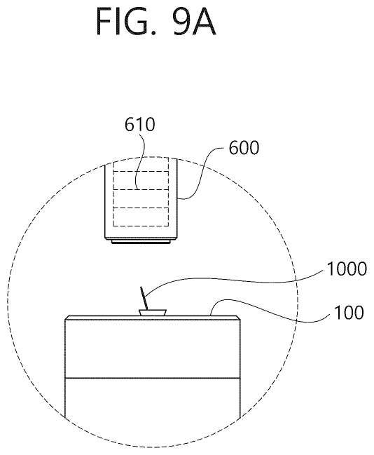

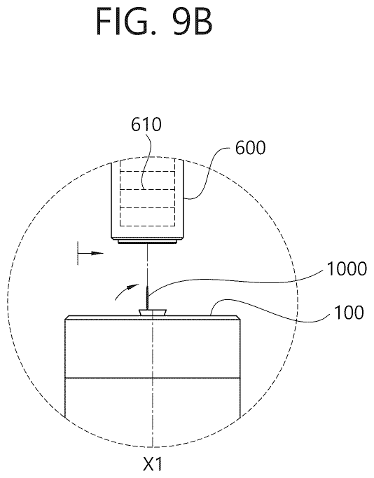

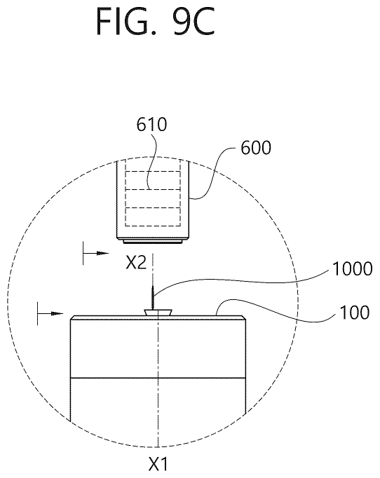

FIGS. 9A, 9B and 9C are using state views showing the concept of adjusting the posture of a pogo pin and coaxially aligning the pogo pin in the first embodiment.

Referring to FIG. 9A, the pogo pin 1000 may be transported from the outside and settled between the upper surface of the seating unit 100 and the upper magnet holder 600. In this case, the posture of the pogo pin may be fixed by the influence of the magnetic force of the lower magnet 200 and the upper magnet 610.

Referring to FIG. 9B, when the upper magnet holder 600 is appropriately moved in the horizontal direction, the direction of the magnetic force acting on the pogo pin 1000 on the lower side changes to uprightly erect the pogo pin 1000 in the vertical direction. In this case, the horizontal movement of the posture adjuster for moving the upper magnet 610 may vary depending on the position and inclination of the pogo pin 1000. In this state, the pogo pin 1000 may be positioned away from the rotation central axis X1 of the rotation unit in a certain direction.

Referring to FIG. 9C, while the pogo pin 1000 is uprightly erect, the coaxial aligner may operate to align the central axis X2 of the pogo pin 1000 and the rotation central axis X1 to be coaxially positioned. Despite the positional movement of the coaxial aligner, the finally moved pogo pin 1000 still maintains the upright posture, and the central axis X2 of the pogo pin 1000 may be positioned coaxially with the central axis X1 of the rotation unit. This may be implemented by the upper magnet 610 and the upper magnet holder 600 maintaining their positions relative to the pogo pin 1000. For example, by moving the upper magnet 610 and the upper magnet holder 600 in response to the movement of the coaxial aligner, the position and distance of the pogo pin 1000 relative to the upper magnet 610 and the upper magnet holder 600 may be maintained. Therefore, in this embodiment, despite the operation of the coaxial aligner, once the pogo pin 1000 stands up in the uprightly erect posture, the pogo pin 1000 may be moved to a position where the rotation central axis X1 and the central axis X2 become coaxial while generally maintaining the uprightly erect posture.

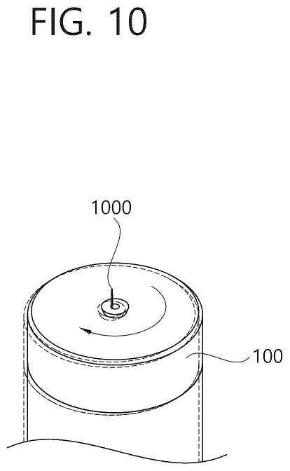

FIG. 10 is an operating state view showing a rotating operation based on a rotation unit in the state that the posture of a pogo pin is adjusted and coaxially aligned according to the first embodiment.

Referring to FIG. 10, the posture of the pogo pin 1000 may be adjusted to be uprightly erected after the pogo pin 1000 is coaxially aligned. In addition, after the posture of the pogo pin 1000 is adjusted to be uprightly erected, an operation for the coaxial alignment may be performed again. This process may be repeatedly performed several times. In this case, the coaxial aligner may align the central axis of the rotation unit with the point where the lower end of the pogo pin 1000 is in contact with the upper surface of the seating unit 100. To this end, the position and posture of the pogo pin 1000 may be identified using a sensor such as a camera so that the coaxial aligner and the posture adjuster can be controlled for the alignment.

In this way, the apparatus for aligning the pogo pin according to the disclosure may be utilized to inspect the outer appearance of the lateral surface of the pogo pin while rotating the pogo pin in the coaxially aligned state. In this case, the center of the seating unit may be different from the center of the rotation unit, and the seating unit may rotate eccentrically depending on the rotation of the rotation unit.

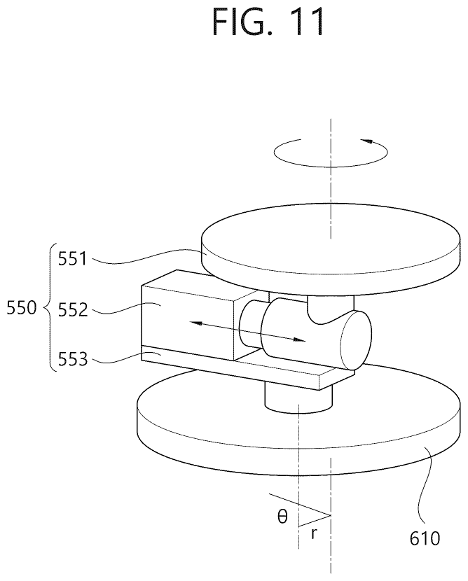

FIG. 11 is a view showing an alternative example of a posture adjuster according to the first embodiment of the disclosure.

Even in the embodiment shown in FIG. 11, the posture of the pogo pin on the lower side may be adjusted using the magnetic force of the posture adjuster. In this case, components other than the posture adjuster may be configured identically or similarly to those of the foregoing description. Therefore, even in the case of including the posture adjuster of FIG. 11, the coaxial aligner may function in a state where the pogo pin is adjusted to have the uprightly erect posture. In addition, when the posture of the pogo pin is tilted during the coaxial alignment process, the posture adjuster may be operated again to adjust the pogo pin to be in the uprightly erect posture.

In the apparatus for aligning the pogo pin, which includes the posture adjuster of FIG. 11, a posture adjuster 550 may include driving elements based on a polar coordinate system to adjust the horizontal position of the upper magnet. As an example, the posture adjuster may include an arm 552 whose length is adjustable, and a rotation actuator 551 capable of rotating the arm. The upper magnet 610 may be fixed to the lower side of the arm 552 through a fixing member 553.

In this alternative example, the posture adjuster 550 may adjust the position of the upper magnet 610 along a r-θ coordinate system (i.e., polar coordinate system). That is, the posture adjuster 550 may adjust the position of the upper magnet 610 on the plane by adjusting an angle θ formed by the center of the upper magnet 610 with respect to the rotation center and a distance r from the rotation center to the center of the upper magnet 610.

However, this configuration of the posture adjuster 550 is merely an example, and the posture adjuster 550 may be implemented to have various configurations capable of adjusting the horizontal position of the upper magnet 610 along the polar coordinate system.

The apparatus for aligning the pogo pin according to the disclosure may adjust the posture to uprightly erect the pogo pin in the vertical direction, and may also be configured to rotate the pogo pin around the longitudinal axis by the rotation unit. The alignment apparatus according to the disclosure may be utilized in an assembly process or appearance inspection for the pogo pin because it is capable of aligning and rotating the pogo pin in a non-contact manner.

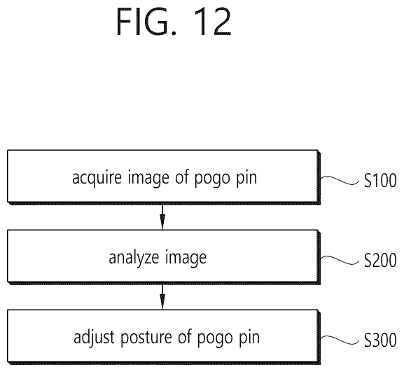

Based on the foregoing description, a method of aligning the pogo pin according to the disclosure and the apparatus for inspecting the appearance of the pogo pin will be described with reference to FIGS. 12 to 26. To avoid redundant description, the same or similar description will be omitted.

FIG. 12 is a flowchart showing a method of aligning a pogo pin according to the first embodiment of the disclosure.

Referring to FIG. 12, the method of aligning the pogo pin according to the first embodiment of the disclosure is performed to uprightly erect the pogo pin seated on the seating unit not in a lying posture.

The method for aligning the pogo pin according to the first embodiment of the disclosure may include operations of acquiring an image of the pogo pin (S100), analyzing the image (S200), and adjusting the posture (S300).

The image acquiring operation S100 for the pogo pin is performed to identify the current seating state of the pogo pin. This operation may be performed using the camera and a lighting unit which are arranged on both sides with the pogo pin seated in the seating unit therebetween. The lighting unit functions as a back light. When an image is acquired with the camera in an operating state, a silhouette image of the pogo pin may be acquired. In addition, although not shown, this operation may be performed by acquiring an image with the camera while irradiating light to the pogo pin using lighting provided coaxially with the camera.

The image analyzing operation S200 is performed to check the angle and central axis of the settled pogo pin. In this operation, the tilted angle of the pogo pin may be identified through a single image. In addition, the point where the lower end of the pogo pin is in contact with the seating unit may be identified and extracted as the coordinates of the central axis when the pogo pin is uprightly erected. However, depending on the shape of the lower end of the pogo pin, a correction or calculation may be performed to extract the correct central axis at the point where the lower end of the pogo pin is in contact with the upper surface of the seating unit.

The posture adjusting operation S300 for the pogo pin refers to an operation of calculating the movement of the posture adjuster for uprightly erecting the pogo pin based on the extracted information about the posture and contact point of the pogo pin, and adjusting the posture of the pogo pin accordingly. This operation may be performed using the magnet that exerts the magnetic force on the pogo pin in a non-contact manner. For example, in this operation, the pogo pin is seated on the upper surface of the seating unit, the magnet provided under the seating unit is moved horizontally to change the direction of the magnetic field, and ultimately the direction of the magnetic field exerted on the pogo pin is changed to adjust the posture of the pogo pin. In this case, the horizontal movement of the magnet may be realized in various configurations capable of moving the position horizontally, such as following the orthogonal coordinate system or the polar coordinate system.

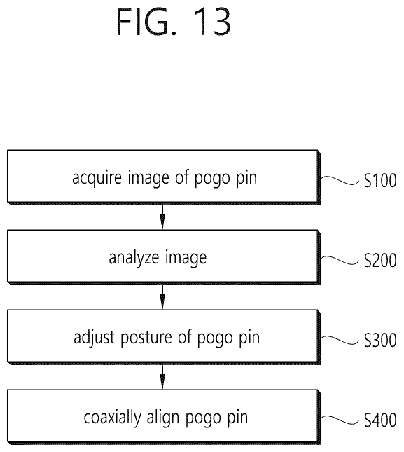

FIG. 13 is a flowchart showing a method of aligning a pogo pin according to a second embodiment of the disclosure.

Referring to FIG. 13, the method for aligning the pogo pin according to the second embodiment of the disclosure may further include an operation of coaxially aligning the pogo pin (S400) after the operation of adjusting the posture of the pogo pin (S300).

The coaxially aligning operation S400 of the pogo pin is performed so that the pogo pin can be coaxially aligned with the rotation center of the rotation unit that rotates the seating unit when the pogo pin is uprightly erected based on the contact coordinates of the lower end of the pogo pin obtained through the foregoing image analyzing operation S200. A calculation unit may obtain the horizontal coordinates for the central axis when the pogo pin is uprightly erected, and calculate a horizontal movement amount so as to match the coordinates of the central axis of the pogo pin with the horizontal coordinates of the central axis of the rotation unit. By horizontally moving the seating unit, for example, by moving the seating unit along the x and y axes in the orthogonal coordinate system, the center axes of the pogo pin and the rotation unit may be aligned coaxially with each other. In this way, the method of aligning the pogo pin according to the disclosure may uprightly erect the posture of the pogo pin, and also align the central axis of the pogo pin coaxially with the rotation axis of the rotation unit.

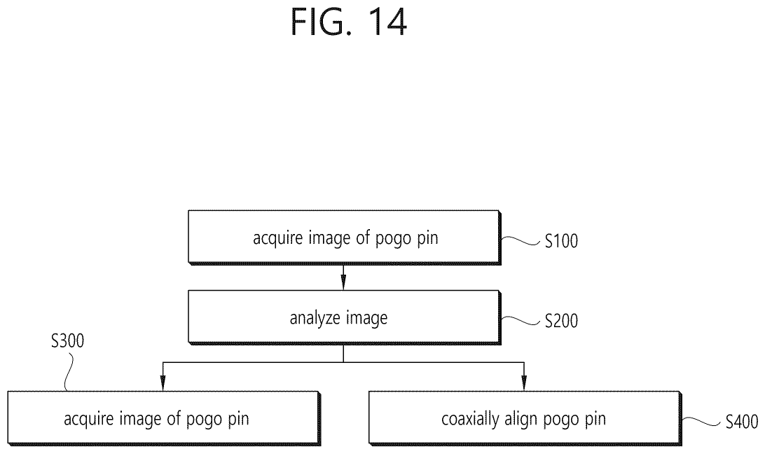

FIG. 14 is a flowchart showing a method of aligning a pogo pin according to an alternative example of the second embodiment of the disclosure.

Referring to FIG. 14, according to the second embodiment of the disclosure, the posture adjusting operation S300 for the pogo pin and the coaxially aligning operation S400 for the pogo pin may be performed simultaneously based on a three-dimensional inclination angle and central axis coordinate information of the pogo pin obtained in the image analyzing operation S200. The posture adjusting operation S300 for the pogo pin and the coaxially aligning operation S400 for the pogo pin may be performed independently of each other through the operations of the posture adjuster and the coaxial adjuster which are configured independently. This means that the angle adjustment of the pogo pin and the horizontal position adjustment of the pogo pin may be performed simultaneously. To this end, the posture adjuster and the coaxial aligner, which may be driven independently, may be used.

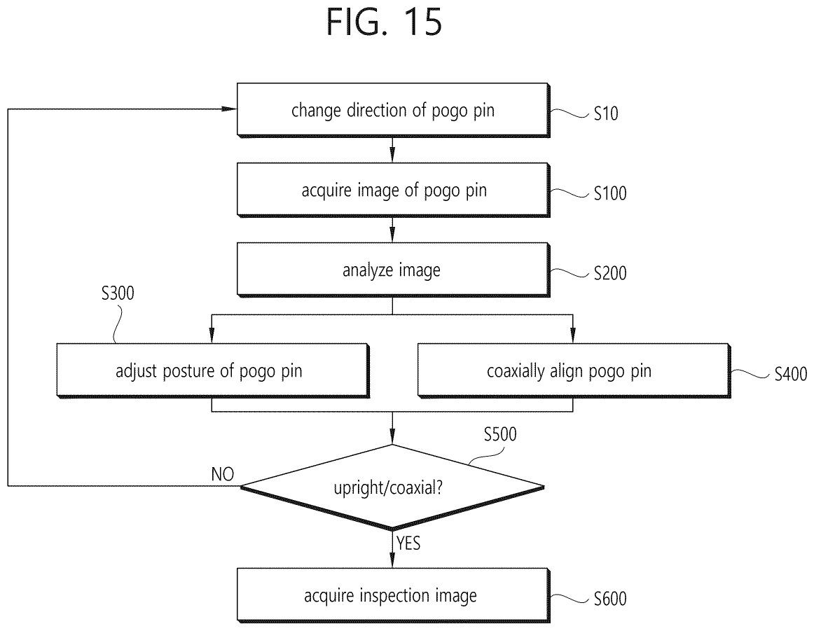

FIG. 15 is a flowchart showing a method of aligning a pogo pin according to a third embodiment of the disclosure.

Referring to FIG. 15, the method of aligning the pogo pin according to the third embodiment of the disclosure may include an operation of changing the direction of the pogo pin (S10), an operation of acquiring an image of the pogo pin (S100), an operation of analyzing the image (S200), an operation of adjusting a posture of the pogo pin (S300), an operation of coaxially aligning the pogo pin (S400), a operation of identifying whether the pogo pin is upright/coaxial (S500), and an operation of acquiring an inspection image (S600).

The direction changing operation S10 for the pogo pin refers to an operation of driving the rotation unit while the pogo pin is seated on the seating unit. When the rotation unit is rotated by a predetermined angle, the direction of the pogo pin captured by the camera may be changed. In this case, the angle may be determined in advance, and for example, the angle may be 90 degrees to correspond to the orthogonal coordinate system.

Thereafter, the image acquiring operation S100 for the pogo pin, the image analyzing operation S200 for the pogo pin, the posture adjusting operation S300 for the pogo pin, and the coaxially aligning operation S400 for the pogo pin may be performed as in the alternative example of the second embodiment described above.

The upright/coaxial identifying operation S500 refers to an operation of identifying whether the posture of the pogo pin is upright at a specific angle and whether the central axis of the rotation unit and the central axis of the pogo pin are aligned coaxially. When an image of the pogo pin is acquired at one angle and posture adjustment and coaxial alignment are performed, it is difficult for the pogo pin to be uprightly erected and completely aligned coaxially with the rotation unit.

Therefore, in this operation, it is identified whether the pogo pin is completely uprightly erected and coaxially aligned.

In this operation, when the pogo pin is not uprightly erected or is not coaxially aligned, the direction of the pogo pin facing the camera is changed again through an operation of changing the direction of the pogo pin. Then, the image acquiring operation S100 for the pogo pin, the image analyzing operation S200 for the pogo pin, the posture adjusting operation S300 for the pogo pin, and the coaxially aligning operation S400 for the pogo pin are performed again. That is, the pogo pin is photographed from various directions to erect the pogo pin uprightly and also to coaxially align the central axis of the pogo pin with the central axis of the rotation unit.

Meanwhile, in the upright/coaxial identifying operation S500, when the pogo pin is vertically erected and the central axis of the pogo pin is aligned coaxially with the central axis of the rotation unit, the inspection image acquiring S600 may be performed.

The inspection image acquiring operation S600 refers to an operation of acquiring an image to inspect the appearance of the pogo pin. This operation may be performed while rotating the pogo pin around the longitudinal axis to acquire an image of a curved lateral surface of the pogo pin. This operation may be performed until the entire area of the lateral surface, i.e., the curved surface corresponding to 360 degrees, is completely photographed.

The acquired inspection image may be used to inspect the appearance of the pogo pin for defects through an image processor.

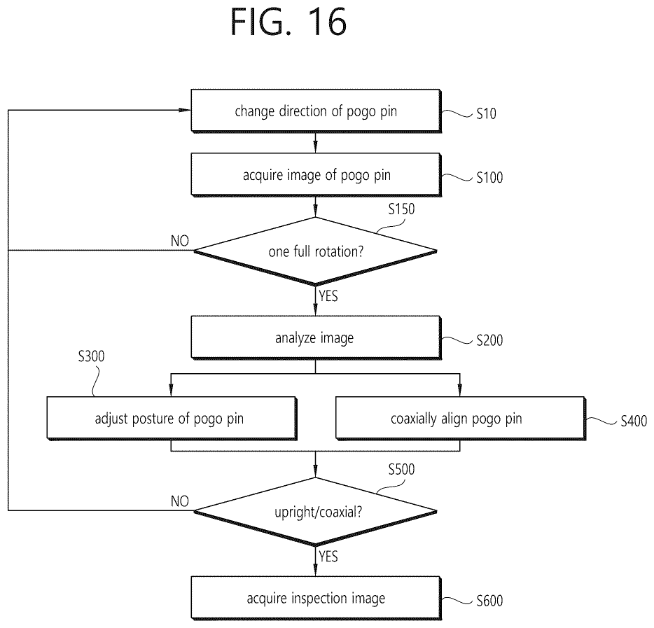

FIG. 16 is a flowchart showing a method of aligning a pogo pin according to a fourth embodiment of the disclosure.

Referring to FIG. 16, the method of aligning the pogo pin according to a fourth embodiment of the disclosure may include operations of capturing images of the pogo pin in advance at various angles, and calculate the horizontal movement of the magnet and the horizontal movement of the seating unit for the uprightly erect posture for each capturing direction based on the images.

In this embodiment, an operation of identifying whether one full rotation is completed may be first performed (S150) after the direction changing operation S10 for the pogo pin and the image acquiring operation S100 for the pogo pin.

Depending on the operation S150 of determining whether one full rotation is completed, the direction of the pogo pin may be changed multiple times during one full rotation. For example, when the direction is changed at 90-degree intervals in the operation S10 of changing the direction of the pogo pin, the operation S150 of identifying whether one full rotation is completed may be performed four times repeatedly after the direction changing operation S10 for the pogo pin and the image acquiring operation S100 for the pogo pin.

Thereafter, when it is identified that one full rotation is completed, the image analyzing operation S200, the posture adjusting operation S300 for the pogo pin, the coaxially aligning operation S400 for the pogo pin, the upright/coaxial identifying operation S500 and the inspection image acquisition operation S600 may be performed.

In this embodiment, when it is identified that the pogo pin is not yet uprightly erected or aligned coaxially in the upright/coaxial identifying operation S500, the operation S150 of identifying whether one full rotation of the pogo pin is completed may be performed again after the direction changing operation S10 for the pogo pin and the image acquiring operation S100 for the pogo pin.

That is, an angle may be adjusted by more than two turns for the upright erection and coaxial alignment of the pogo pin.

Afterwards, when the pogo pin is photographed from various directions, and it is identified in the upright/coaxial identifying operation S500 that the uprightly erect posture and coaxial alignment are completed, an operation of acquiring an inspection image (S600) may be performed.

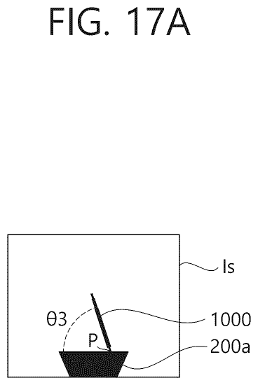

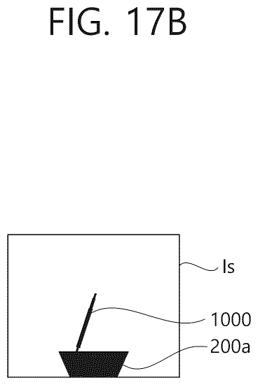

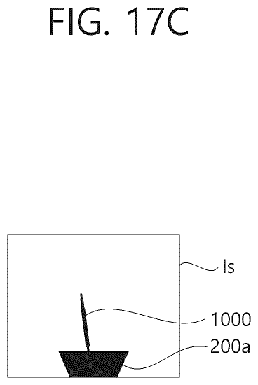

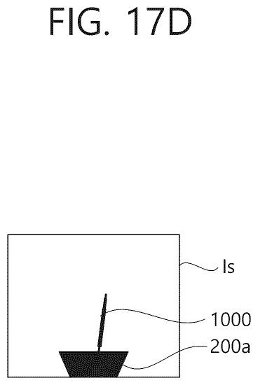

FIGS. 17A, 17B, 17C and 17D are a view showing image acquired in a process of aligning the posture of a pogo pin according to the disclosure.

Referring to FIG. 17A, in an image Is of the pogo pin 1000 acquired at a first angle (90 degrees), the pogo pin 1000 is not erected on the seating unit 200a and is not coaxially aligned. In this case, an angle θ3 of the pogo pin and coordinates P at which the pogo pin is in contact with the seating unit 200a are identified.

Referring to FIGS. 17B, 17C and 17D, the direction changing operation S10 for the pogo pin and the image acquiring operation S100 of the pogo pin are repeatedly performed as the angle is changed, so that images of the pogo pin 1000 at 180 degrees, 270 degrees, and 360 degrees can be acquired.

Afterwards, through the image analyzing operation S200, the calculation unit extracts the tilted posture of the pogo pin 1000 and calculates the position change amount of the magnet to uprightly erect the pogo pin 1000. Based on this, the controller operates the posture adjuster and moves the magnet horizontally. As a result, the pogo pin 1000 is uprightly erected on the seating unit 200a.

In addition, the calculation unit calculates a horizontal movement value of the seating unit 200a for the coaxial alignment of the pogo pin 1000. In this case, when the seating unit 200a is horizontally moved, the pogo pin 1000 is also horizontally moved. Therefore, even when only the horizontal movement amount of the coaxial aligner is calculated, the horizontal position of the pogo pin 1000 is aligned based on this.

The coaxially aligning operation S400 for the pogo pin refers to an operation in which the controller controls the coaxial aligner based on the calculated horizontal movement value of the coaxial aligner. In this operation, the controller horizontally moves the coaxial aligner to coaxially align the central axis of the rotation unit with the central axis of the pogo pin 1000.

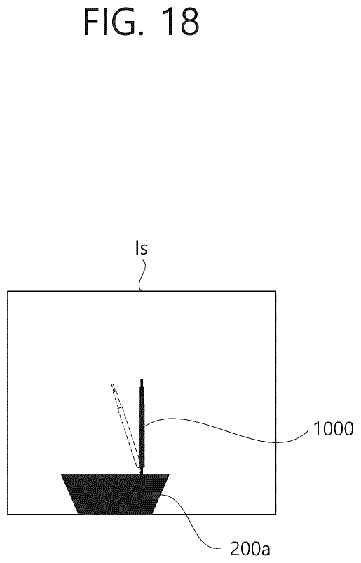

FIG. 18 shows an image acquired by capturing a pogo pin coaxially aligned and uprightly erect according to the disclosure.

Referring to FIG. 18, the pogo pin 1000 may be uprightly erected through the posture adjusting operation S300 for the pogo pin and the coaxially aligning operation S400 for the pogo pin according to the disclosure, and the pogo pin 1000 may be uprightly erected and also coaxially aligned based on the posture correction and horizontal movement values calculated for each direction.

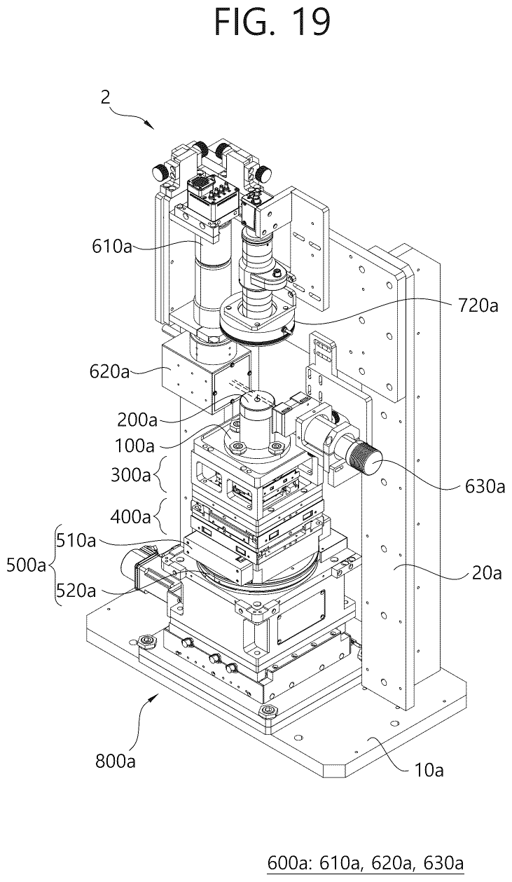

Hereinafter, with reference to FIGS. 19 to 26, the apparatus for inspecting the appearance of the pogo pins by which the method of aligning the pogo pin according to an embodiment of the disclosure is implemented will be described.

The foregoing method of aligning the pogo pin according to the disclosure may be realized by the controller for controlling the driving elements of the apparatus for inspecting the appearance of the pogo pin and an image processing unit for processing the acquired images set forth herein. Further, although the redundant description is avoided, it is obvious that at least some of the operations included in the method of aligning the pogo pin according to the disclosure may be performed by the foregoing apparatus for aligning the pogo pin according to the first embodiment.

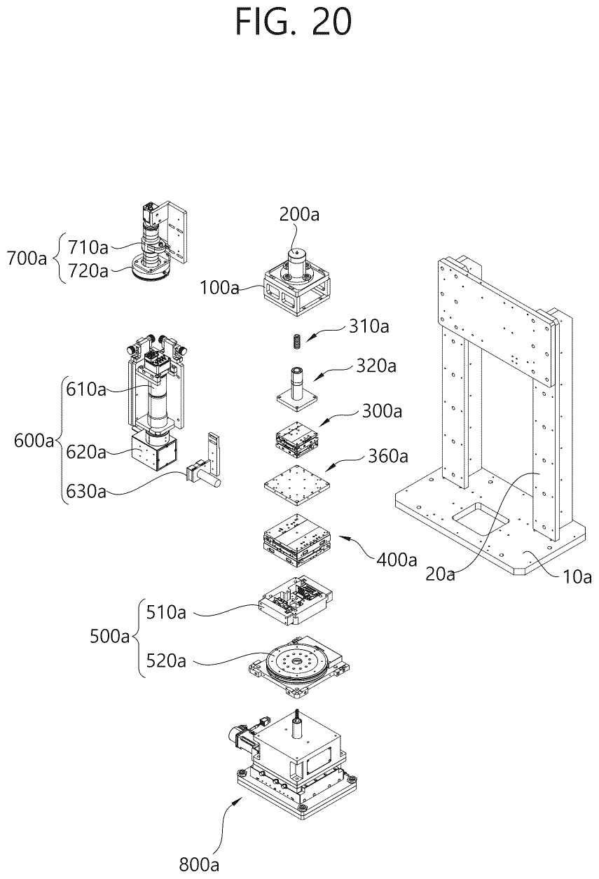

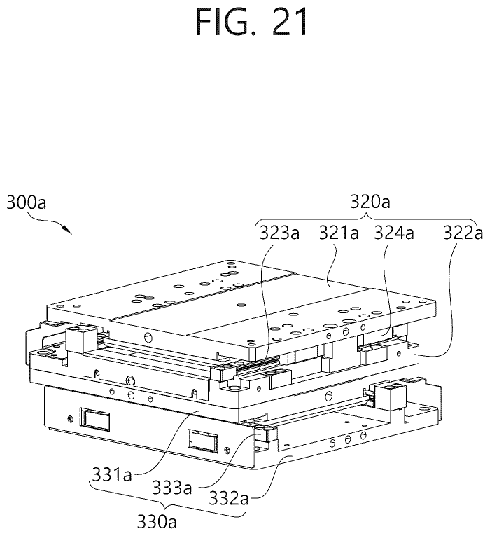

FIG. 19 is a perspective view of an apparatus 2 for inspecting the appearance of a pogo pin according to an embodiment of the disclosure, FIG. 20 is an exploded perspective view of an apparatus 2 for inspecting the appearance of a pogo pin according to an embodiment of the disclosure, and FIG. 21 is a perspective view showing a posture adjuster 300a included in an apparatus for inspecting the appearance of a pogo pin according to an embodiment of the disclosure.

Referring to FIGS. 19 to 21, the inspection device 2 for the appearance of the pogo pins according to the disclosure may include a lower frame 10a, a vertical frame 20a, a seating unit 200a, a posture adjuster 300a, a coaxial aligner 400a, a rotation unit 500a, a vision module, a focus adjuster 800a, an image processor (not shown), and a controller (not shown).

The lower frame 10a and the vertical frame 20a are used as a base to which the components to be described later will be mounted. The lower frame 10a may extend in a horizontal direction to have a predetermined size. The vertical frame 20a may be coupled to one side of the lower frame 10a, and extend a predetermined length in a vertical direction.

The seating unit 200a is configured to seat the pogo pin 1000 on the top surface thereof. At least a portion of the top surface of the seating unit 200a may be configured to have a predetermined area and support a longitudinal end portion of the pogo pin 1000. The seating unit 200a transmits the magnetic force of a magnet 310a (to be described later) so that the pogo pin 1000 may be seated thereon having an approximately uprightly erect posture.

The seating unit 200a may be coupled to an upper portion of a holding frame 100a. The holding frame 100a may be provided at a predetermined height in the vertical direction, and have a space for accommodating the posture adjuster 300a (to be described later) therein. Further, a lower portion of the holding frame 100a may be coupled to the coaxial aligner 400a (to be described later).

The top surface of the seating unit 200a may be configured to prevent the end portion of the pogo pin 1000 being in contact therewith from slipping over thereon. The top surface of the seating unit 200a may be treated to increase friction.

The posture adjuster 300a is configured to adjust the posture of the pogo pin 1000 seated on the seating unit 200a. The posture adjuster 300a is configured to adjust the pogo pin 1000 to be uprightly erect on the seating unit 200a.

The posture adjuster 300a may be provided under the seating unit 200a and configured to horizontally move relative to the seating unit 200a.

The posture adjuster 300a may include the magnet 310a, a magnet holder 311a, a first adjusting unit 320a, and a second adjusting unit 330a.

The magnet 310a is provided under the seating unit 200a, and configured to transmit the magnetic force to the pogo pin 1000 seated on the top of the seating unit 200a. The magnet 310a may include one or more magnets. The magnet holder 311a may arrange at least one magnet 310a brick by brick in the vertical direction. The top of the magnet holder 311a may be spaced apart from the bottom of the seating unit 200a. The position of the magnet holder 311a may be adjusted depending on change in the position of the first adjusting unit 320a (to be described later).

The first adjusting unit 320a may be configured to horizontally move the position of the magnet 310a along a first direction. The first adjusting unit 320a may include a first upper portion 321a and a first lower portion 322a. The first upper portion 321a and a second lower portion 332a may be provided as flat plates, respectively. The first upper portion 321a and the first lower portion 322a may be coupled by a guide 323a to restrict their moving directions. Between the first upper portion 321a and a second upper portion 331a may be provided a first actuator 324a to adjust a relative position between the first upper portion 321a and the first lower portion 322a.

The second adjusting unit 330a may be configured to horizontally move in a second direction perpendicular to the moving direction of the first adjusting unit 320a. The second adjusting unit 330a may include the second upper portion 331a and the second lower portion 332a. The second upper portion 331a may engage with the first lower portion 322a of the first adjusting unit 320a. The second upper portion 331a and the second lower portion 332a may be coupled by a guide to move in the second direction. Between the second upper portion 331a and the second lower portion 332a may be provided a second actuator to adjust the position of the second upper portion 331a.

Meanwhile, the first actuator 324a and the second actuator according to the disclosure may include linear motors, but are not limited thereto. Alternatively, a ball-screw mechanism or the like actuator for linear movement may be used.

However, such a configuration of the posture adjuster 300a is merely an example, and may be implemented as modified in various ways as long as it may adjust the horizontal position of the magnet 310a.

The coaxial aligner 400a is provided to coaxially align the center of the pogo pin 1000 and the rotation center when the pogo pin 1000 is uprightly erect. The coaxial aligner 400a may include a first alignment unit and a second alignment unit.

An upper portion of the first alignment unit and a lower portion of the second adjusting unit 330a may be coupled to each other with a coupling plate 360a therebetween. The second alignment unit may be coupled to a lower portion of the first alignment unit. A lower portion of the second alignment unit may be coupled to a rotation table 510a.

The configurations of the first alignment unit and the second alignment unit may be similar to those of the first adjusting unit 320a and the second adjusting unit 330a linearly moving on a horizontal plane. In other words, the upper unit may be configured to linearly move on the lower unit. Further, the actuator may be provided between the upper unit and the lower unit to move the upper unit linearly.

The coaxial aligner 400a may operate to adjust the horizontal position of the central axis of the pogo pin 1000 within a predetermined range, thereby coaxially aligning the central axis of the pogo pin 1000 with the rotation center of the rotation unit 500a.

The rotation unit 500a may be configured to adjust the angle of the coaxial aligner 400a, the posture adjuster 300a, and the seating unit 200a. When the rotation unit 500a rotates the coaxial aligner 400a, the posture adjuster 300a and the seating unit 200a may be rotated together at the same angle.

The rotation unit 500a may include the rotation table 510a, and a rotation actuator 520a. The top of the rotation table 510a may be coupled to the coaxial aligner 400a. The bottom of the rotation actuator 520a may be coupled to the focus adjuster 800a.

The rotation table 510a may be configured to be infinitely rotated by the rotation actuator 520a. However, this configuration is merely an example, and may be modified to operate within a certain rotation angle by a wire-type connector. However, even in this case, it is ensured that the rotation table 510a rotates at least 360 degrees.

The vision module is configured to acquire the images of the pogo pin 1000 seated on the seating unit 200a. The vision module may include a first vision module 600a to acquire a lateral-view image of the pogo pin 1000, and a second vision module 700a to acquire a top-view image of the pogo pin 1000.

The first vision module 600a may include a first camera 610a, a first lighting unit 620a, and a rear lighting unit 630a.

The first camera 610a may include an image sensor and a lens kit.

The rear lighting unit 630a and the first camera 610a may be horizontally placed on both sides with the pogo pin 1000 seated on the seating unit 200a therebetween. The first lighting unit 620a may be coupled to the first camera 610a. Further, the first lighting unit 620a may be configured as lighting provided coaxially with a camera.

The second vision module 700a may include a second camera 710a, and a second lighting unit 720a. The second camera 710a may be provided vertically above the seating unit 200a. The pogo pin 1000 may be varied in position depending on the operations of the coaxial aligner 400a, but the second camera 710a may be configured to acquire the top-view image of the pogo pin 1000 even though the position of the pogo pin 1000 is changed. The second lighting unit 720a may be coupled to the second camera 710a.

The focus adjuster 800a may be configured to move on the lower frame 10a in a certain direction. The focus adjuster 800a is configured to make the lateral surface of the pogo pin be positioned at the focus of the first camera 610a according to the thicknesses of various pogo pins. The focus adjuster 800a may simultaneously move the rotation unit 500a, the coaxial aligner 400a, the posture adjuster 300a, and the seating unit 200a, which are connected upward along a direction faced by the rear lighting unit 630a.

Although not shown, the inspection device 2 for the appearance of the pogo pins according to the disclosure may include the image processor and the controller.

The image processor is configured to identify whether there is a defect in the appearance of the pogo pin 1000 based on the lateral- and top-view images of the pogo pin 1000. The image processor may stitch the lateral-view images taken at various angles into a completely planar inspection image corresponding to one revolution. The image processor may detect the presence of a defect based on the inspection image.

The controller may control the pogo pin 1000 to be adjusted in posture and aligned coaxially based on the image acquired by the vision module. After the pogo pin 1000 is uprightly erected and coaxially aligned, the controller may control the vision modules and the rotation actuator 520a to acquire the images of the pogo pin 1000 at various angles.

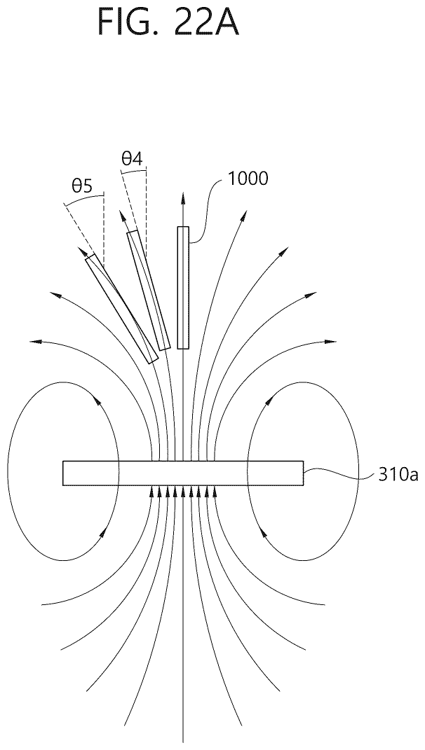

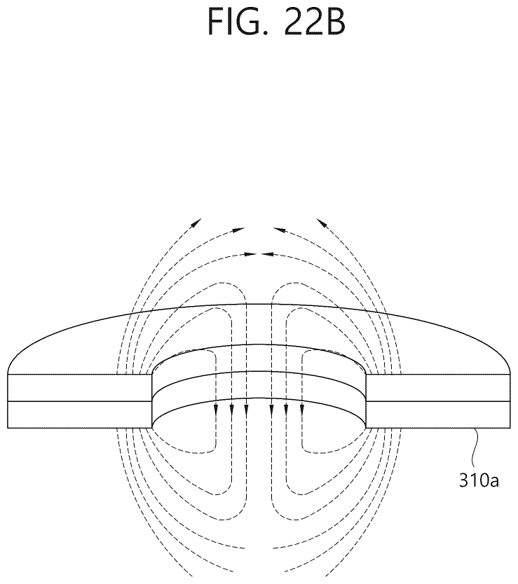

FIGS. 22A and 22B are conceptual views showing a magnet used in a posture adjusting operation according to the disclosure and the lines of magnetic force.

Referring to FIG. 22A, the magnet 310a according to an embodiment of the disclosure is shaped like a disc, and the pogo pin 1000 may receive magnetic force in different directions corresponding to its relative positions from the center of the magnet 310a. In the center of the magnet 310a, the lines of magnetic force are formed in approximately vertical directions. As a distance from the center of the magnet 310a increases, slopes θ4 and θ5 of the lines of magnetic force may increase. Therefore, by adjusting the relative position of the pogo pin 1000 to the center of the magnet 310a and the pogo pin 1000 to change the orientation of the lines of magnetic force acting on the pogo pin 1000, it is possible to contactlessly adjust the posture (angle or tilt) of the pogo pin 1000.

Referring to FIG. 22B, the magnet 310a according to an embodiment of the disclosure is shaped like a ring. When the magnet 310a is shaped like a ring, the lines of magnetic force are formed in vertical directions in a hollow formed in a center portion of the ring to increase magnetic flux, thereby allowing the posture of the pogo pin 1000 to be more easily adjusted.

However, the foregoing shape of the magnet 310a is merely an example, and the disclosure is not limited to this example. That is, just like the foregoing apparatus for aligning the pogo pin according to the first embodiment, an apparatus for inspecting the appearance of the pogo pin according to an embodiment of the disclosure may also include the magnet 310a having various shapes and configurations. Because alternative examples have already been described, the redundant description will be omitted

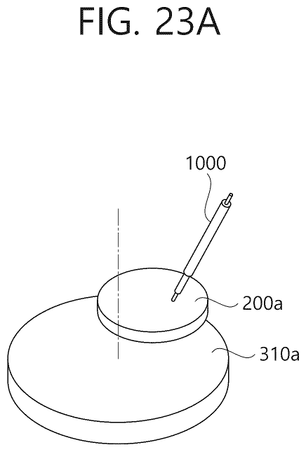

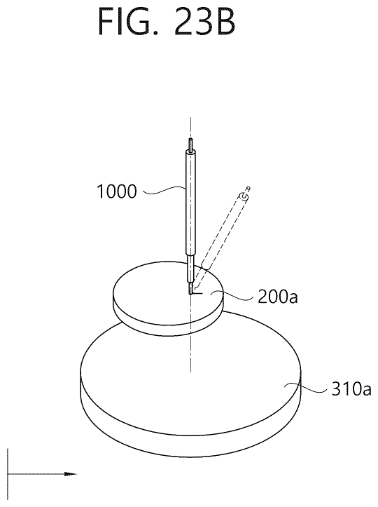

FIGS. 23A and 23B are conceptual views showing the postures of a pogo pin based on a posture adjusting operation for the pogo pin according to the disclosure.

Referring to FIG. 23A, as described above, the pogo pin 1000 seated on the seating unit 200a may not be uprightly erected. Further, a contact point at which the pogo pin 1000 is in contact with the seating unit 200a may be spaced apart from the rotation center of the rotation actuator 520a. The pogo pin 1000 may be kept at an angle tilted by the magnet 310a while its lower end is being in contact with the seating unit 200a.

Referring to FIG. 23B, when the position of the magnet 310a is adjusted in the horizontal direction in the posture adjusting operation S300, preferably, when the horizontal position of the lower end of the pogo pin 1000 is aligned with the central position of the magnet 310a, the pogo pin 1000 is uprightly erected. In this way, the posture of the pogo pin 1000 is adjusted based on the magnetic force varied depending on the relative positions of the magnet 310a.

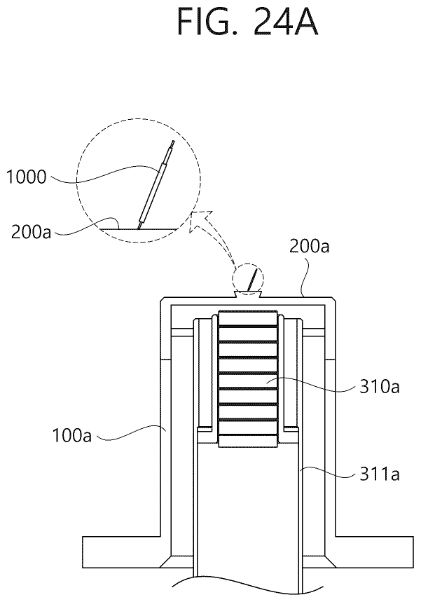

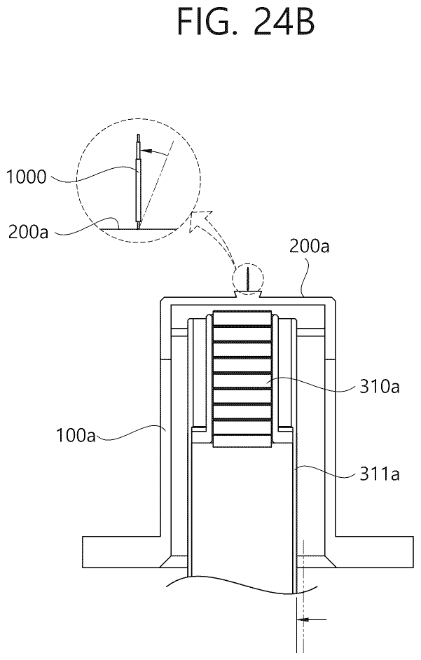

FIGS. 24A and 24B are cross-sectional views showing states of using a posture adjuster in a posture adjusting operation for a pogo pin according to the disclosure.

Referring to FIG. 24A, the pogo pin 1000 seated on the seating unit 200a is kept tilted. In this case, the pogo pin 1000 may be automatically transferred and seated on the seating unit.

Referring to FIG. 24B, the tilt of the pogo pin 1000 extracted in the image analyzing operation S200 is received, and the operation of the posture adjuster 300a is identified to uprightly erect the pogo pin 1000. For example, the controller may control the magnet 310a of the posture adjuster 300a to move leftwards in FIG. 24B with respect to the pogo pin 1000 being in the state of in FIG. 24A. As a result, the pogo pin 1000 becomes uprightly erect.

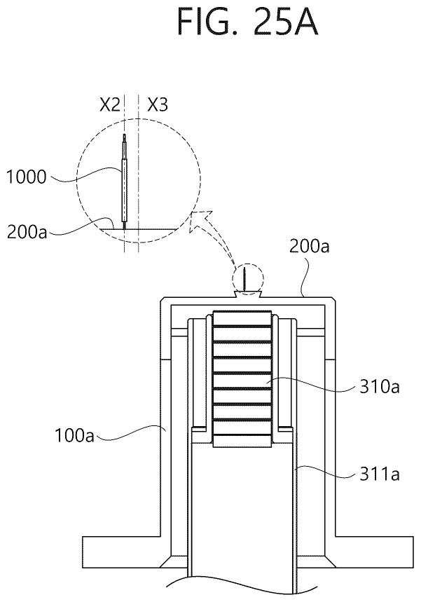

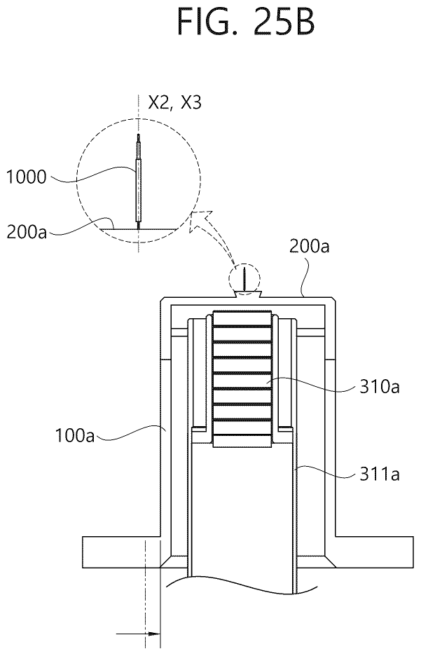

FIGS. 25A and 25B are cross-sectional views showing states of using a coaxial aligner in a coaxial aligning operation for a pogo pin according to the disclosure.

Referring to FIG. 25A, based on information received in the image analyzing operation S200 according to an embodiment of the disclosure, a position difference between a central axis X3 of the rotation unit 500a (see FIG. 20) and a central axis X2 of the pogo pin 1000 in an upright posture may be first calculated. Based on the calculated value, the coaxially aligning operation S400 for the pogo pin may be performed to coaxially align the central axis X2 of the pogo pin 1000 with the central axis X3 of the rotation unit 500a.

Referring to FIG. 25B, in the coaxially aligning operation S400 for the pogo pin, the coaxial aligner 400a (see FIG. 20) is operated by the controller so that the central axis X2 of the pogo pin 1000 and the central axis X3 of the rotation unit 500a can be aligned at the same position or positioned very close to each other.

The foregoing posture adjustment and coaxial alignment of the pogo pin 1000 may be performed multiple times at different angles by operating the rotation unit 500a. For example, the controller may perform the control for the posture adjustment and the central axis alignment whenever the rotation unit 500a is rotated 90 degrees.

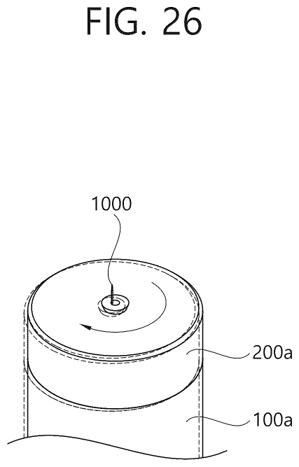

FIG. 26 shows a rotating operation of a pogo pin in an inspection image acquiring operation according to the disclosure.

Referring to FIGS. 26 and 20 together, in the upright/coaxial identifying operation S500 for the pogo pin, it may be identified whether the pogo pin 1000 photographed at multiple angles is in the uprightly erect posture and whether the pogo pin 1000 is aligned coaxially with the rotation unit 500a. When the uprightly erect posture and coaxial alignment of the pogo pin 1000 are completed, the inspection image acquiring operation S600 may be performed

In the inspection image acquiring operation S600, the controller may control the first vision module 600a and the second vision module 700a to operate and acquire images. In this case, the controller may operate the rotation actuator 520a and control the vision modules 600a and 700a to acquire the images of the pogo pin 1000 at each predetermined angle. In some cases, the central axis of the seating unit 200a and the rotation axis of the rotation unit 500a may be different from each other, and thus the seating unit 200a may rotate eccentrically depending on the rotation of the rotation unit 500a.

As described above, by the method of aligning the pogo pin according to the disclosure, the pogo pin is quickly and accurately erected uprightly and aligned with the rotation axis in a non-contact manner.

According to the disclosure, the apparatus and method for aligning the pogo pin have effects on quickly and accurately aligning the pogo pin in the non-contact manner.

Further, the apparatus and method for aligning the pogo pin according to the disclosure align the pogo pin in the non-contact manner, thereby preventing the pogo pin from being damaged.

Further, the apparatus and method for aligning the pogo pin according to the disclosure quickly and accurately perform the operation of uprightly erecting the pogo pin and the operation of aligning the pogo pin coaxially with the rotation axis.

### REFERENCE NUMERALS

100, 200a: seating unit
300, 400a: coaxial aligner
400, 500a: rotation unit
500, 300a: posture adjuster
1000: pogo pin

What is claimed is:

1. An apparatus for aligning a pogo pin, comprising:
a seating unit configured to support and seat a lower end portion of the pogo pin on an upper surface thereof;
a lower magnet configured to provide a magnetic force from below the seating unit so that the pogo pin can maintain a standing state on the seating unit; and
a posture adjuster provided above the pogo pin and configured to adjust the posture of the pogo pin based on the magnetic force.

2. The apparatus of claim 1, further comprising an upper magnet provided blow the posture adjuster.

3. The apparatus of claim 2, wherein
a lower end of the posture adjuster is spaced apart at a predetermined distance from the upper surface of the seating unit, and
the predetermined distance is determined to be greater than the length of the pogo pin.

4. The apparatus of claim 3, wherein the posture adjuster is configured to move the upper magnet in a horizontal direction.

5. The apparatus of claim 4, wherein the posture adjuster comprises:
an upper magnet holder configured to hold the upper magnet; and
at least one adjustment module configured to move the upper magnet holder.

6. The apparatus of claim 5, wherein the adjustment module is provided in plural and is configured to move along an orthogonal coordinate system.

7. The apparatus of claim 5, wherein the adjustment module is provided in plural and is configured to move along a polar coordinate system.

8. The apparatus of claim 5, wherein the posture adjuster is configured to uprightly erect the pogo pin according to positions of the upper magnet.

9. The apparatus of claim 2, further comprising a coaxial aligner configured to move the seating unit on a horizontal plane.

10. The apparatus of claim 9, wherein the posture adjuster is controlled to operate after the coaxial aligner aligns the position of the seating unit.

11. A method of aligning a pogo pin, comprising:
acquiring an image of the pogo pin;
analyzing the image to extract information about a posture and position of the pogo pin from the image; and
adjusting the posture to change a direction of a magnetic force acting on the pogo pin so as to adjust the posture of the pogo pin based on the information.

12. The method of claim 11, wherein
a seating unit on which the pogo pin is seated is configured to rotate, and
the method further comprises coaxially aligning a central axis of the pogo pin with a rotation center of the seating unit based on the information.

13. The method of claim 12, wherein the acquiring the image of the pogo pin is performed using a lighting unit and a camera provided on both sides with the pogo pin therebetween.

14. The method of claim 13, wherein the acquiring the image of the pogo pin is performed using a silhouette image of the pogo pin.

15. The method of claim 14, further comprising adjusting an angle to rotate the seating unit at a predetermined angle so as to adjust a direction in which the pogo pin appears in the camera.

16. The method of claim 15, wherein the acquiring the image is performed for each direction of the pogo pin.

17. The method of claim 16, wherein the analyzing the image, the adjusting the posture, and the coaxially aligning the pogo pin are performed after acquiring the images of the pogo pin from a predetermined number of directions.

18. The method of claim 16, wherein the analyzing the image, the adjusting the posture, and the coaxially aligning the pogo pin are performed after acquiring the images of the pogo pin from the respective directions.

19. The method of claim 13, wherein the adjusting the posture of the pogo pin is performed by moving a position of the magnet on a horizontal plane along an orthogonal coordinate system.

20. The method of claim 13, wherein the coaxially aligning the pogo pin is performed by moving the seating unit along an orthogonal coordinate system.
